(19) United States
(12) Patent Application Publication
(10) Pub. No.: US 2024/0383268 A1
(43) Pub. Date: Nov. 21, 2024

(54) LASER COLORED PRODUCT, LASER COLORING METHOD THEREFOR, AND LASER COLORING SYSTEM USING THE SAME

(71) Applicant: NATIONAL TSING HUA UNIVERSITY, Hsinchu City (TW)

(72) Inventors: Hung-Wen Chen, Hsinchu City (TW); Chia-Hung Chou, Taipei City (TW); Yi-Jiun Shen, Taoyuan City (TW); Chien-Hung Chen, New Taipei City (TW)

(73) Assignee: NATIONAL TSING HUA UNIVERSITY, Hsinchu City (TW)

(21) Appl. No.: 18/397,636

(22) Filed: Dec. 27, 2023

(30) Foreign Application Priority Data
May 19, 2023 (TW) 112118652

(51) Int. Cl. B41M 5/26; B23K 26/00; B23K 26/082; B23K 26/70

(52) U.S. Cl. CPC B41M 5/262; B23K 26/0006; B23K 26/082; B23K 26/703

(57) ABSTRACT

A laser colored product, a laser coloring method therefor, and a laser coloring system using the same are provided. The laser coloring method comprises the following steps. First, provide a processing workpiece which includes a processing part, and the processing part includes a pattern region. The processing part within the pattern region includes an inner portion and an outer layer, and the outer layer includes metal materials. Use the laser coloring system to irradiate the outer layer of the pattern region in stages to convert the outer layer of the pattern region into a metal color pattern layer. The metal color pattern layer includes metal materials or metal compounds of metal materials, and the metal color pattern layer includes a plurality of pixel units arranged in arrays, wherein each of the pixel units includes a pixel color, and each of the pixel units has a pixel width or a pixel length between 1 μm to 500 μm.

### TECHNICAL FIELD

The present disclosure relates to a laser colored product and a laser coloring method, specifically, a color pattern laser colored product and a laser coloring method thereof.

### BACKGROUND

Metal materials are usually used in the casing or external structure of commonly-used products, e.g., casing of electrical products, frames of bicycles, and wheels of car. One of the reasons to use metal materials is that metal materials have better rigidity and impact resistance than ceramic or plastic materials. However, the monochromatic color tone of the metal surface is difficult to satisfy a user's different design requirements for product appearance. Thus, a plurality of technologies have been gradually developed for forming color patterns on metal surfaces.

Common coloring technologies for metal surfaces include ink-jet coloring, thermal transfer coloring, metal plating, etc. Ink-jet coloring uses spraying and blending with solvents. Pigment of the target color in the paint is sprayed onto an object surface by the painting process. Then, through a roasting process, the pigment is fixed on the surface of the object to achieve the goal of coloring. A common example is the paint coated on a car's surface. However, during the spraying process, the thickness of the paint is usually inconsistent and the pigment could accumulate in some areas, making the final product difficult to meet final quality requirement. In addition, during the spraying process, the solvent is dispersed in the air, causing air pollution or occupational injury to the practitioner. As such, there are still many restrictions in the use of the ink-jet coloring.

Thermal transfer coloring involves the use of a ready-made transferring film. The art pattern on the transferring film is transferred onto a metal plate surface by heating and pressing. However, the transferred pigment falls off easily due to sun exposure or friction after long-time use on metal object such as a door knob.

Metal plating includes a color metal film coated on an object surface such as a nickel or copper-coated car wheel. The color metal film can produce antirust and esthetic effects; however, it is difficult to achieve the color pattern design requirement of a product.

Furthermore, when the metal case surface of the electronic product needs to have an anti-counterfeiting label or an identification label such as a quick response code (QR code), problems such as mis-identification or failure of identification due to poor resolution or contrast of the label often occur.

Therefore, how to produce high-resolution color pattern on metal surfaces which meets the required esthetics of product design, is easy to identify, is durable and not easily worn off, and the production process of which conforms to environmental requirements, does not cause too much environmental pollution nor occupational injury of practitioners, is an urgent problem to be solved for people skilled in the art.

### SUMMARY

An object of the present invention is to provide a laser colored product and a laser coloring method therefor. Using a laser coloring system to perform a laser coloring process on the metal surface of a processing workpiece can achieve the goal of producing high resolution color pattern on a metal surface. In addition, when applied to the identification of labels, the invention can achieve the goal of easy identification and solve the problem of poor identification. Furthermore, the laser coloring process is relatively clean and safe, it does not cause environmental pollution nor does it cause occupational injury for practitioners. During the laser coloring process, heat can be efficiently dissipated, so that imperfections such as color cast due to insufficient heat dissipation of local areas on the metal surface can be decreased.

An embodiment of the invention provides a laser coloring method, and the method includes the following steps. First, provide a processing workpiece which includes a processing part, and the processing part includes a pattern region. The pattern region of the processing part includes an inner portion and an outer layer, and the outer layer includes metal materials. Use the laser coloring system to irradiate the outer layer of the pattern region in stages to convert the outer layer of the pattern into a metal color pattern layer. The metal color pattern layer includes metal materials or metal compounds of metal materials, and the metal color pattern layer includes a plurality of pixel units arranged in arrays, wherein each of the pixel units includes a pixel color, and each of the pixel units has a pixel width or a pixel length between 1 μm to 500 μm.

Another embodiment of the invention provides a laser colored product which comprises a processing part and a metal color pattern layer. The processing part comprises an inner portion and a pattern portion. The metal color pattern layer is disposed on the inner portion of the pattern portion. The metal color pattern layer includes metal materials or metal compounds of metal materials, and the metal color pattern layer includes a plurality of pixel units arranged in arrays, wherein each of the pixel units includes a pixel color, and each of the pixel units has a pixel width or a pixel length between 1 μm to 500 μm.

Still another embodiment of the invention provides a laser coloring system which comprises a laser source, a shutter and a scanning system. The laser source irradiates a laser beam. The shutter controls the time the laser beam passes through the shutter. The scanning system receives the laser beam and irradiates the laser beam onto the outer layer of a pattern region of a processing workpiece, and irradiates the outer layer of the pattern region in stages to convert the outer layer into a metal color pattern layer. The metal color pattern layer includes metal materials or metal compounds of metal materials. The metal color pattern layer includes a plurality of pixel units arranged in arrays, wherein each of the pixel units includes a pixel color, and each of the pixel units has a pixel width or a pixel length between 1 μm to 500 μm.

Still another embodiment of the invention provides a laser colored product which includes a processing part and a metal color pattern layer. The processing part comprises an inner portion and a pattern region. The metal color pattern layer is disposed on the inner portion. The metal color pattern layer includes metal materials or metal compounds of metal materials. The metal color pattern layer includes a plurality of pixel units arranged in arrays, wherein each of the pixel units includes a first subpixel and a second subpixel, and the first subpixel includes a first subpixel color, and the second subpixel includes a second subpixel color.

Compared to prior art, the laser colored product and the laser coloring method therefor use the laser coloring system to perform the laser coloring process on the metal surface of the processing workpiece, and a metal color pattern layer is formed and contains a plurality of pixel units arranged in arrays. Each of the pixel units includes a pixel color, and each of the pixel units has a pixel width or a pixel length between 1 μm to 500 μm. The goal of producing high resolution color patterns can be achieved, and the identification efficiency is improved. The laser coloring technology of the invention can replace the other metal coloring methods. The laser coloring technology of the present invention is not likely to cause occupational injury and is relatively clean and safe. It can reduce environmental pollution, so that the requirements of modern environmental protection can be met. The laser coloring process can achieve efficient heat dissipation and decrease heat accumulation in local areas of the metal surface of the processing workpiece due to poor heat dissipation. The coloring structure in local areas won't be uneven due to heat accumulation, and imperfections such as color cast or uneven color in local areas will not occur.

### BRIEF DESCRIPTION OF THE DRAWINGS

FIG. 1 is a flow chart of a laser coloring method according to an embodiment of the invention.

FIG. 2A is a schematic cross-sectional view of a processing workpiece according to an embodiment of the invention.

FIG. 2B is a schematic top view of a processing workpiece according to an embodiment of the invention.

FIG. 3 is a schematic structural view of a laser coloring system according to an embodiment of the invention.

FIG. 4A is a schematic stereoscopic structural view of a scanning system according to an embodiment of the invention.

FIG. 4B is a schematic stereoscopic structural view of a processing platform according to an embodiment of the invention.

FIG. 4C is a schematic stereoscopic structural view of a heat dissipating platform according to an embodiment of the invention.

FIG. 4D is a schematic stereoscopic structural view of a heat dissipating platform according to an embodiment of the invention.

FIG. 4E is a schematic stereoscopic structural view of a processing groove according to another embodiment of the invention.

FIG. 5A is a schematic structural view of a laser coloring system according to another embodiment of the invention.

FIG. 5B is a schematic view of a laser speckle using a diffraction optical element according to another embodiment of the invention.

FIG. 6A is a schematic cross-sectional view of a laser colored product according to an embodiment of the invention.

FIG. 6B is a schematic top view of a laser colored product according to an embodiment of the invention.

FIG. 6C is a schematic stereoscopic structural view of a laser colored product according to an embodiment of the invention.

FIG. 7A is a partially enlarged schematic diagram of a local area of a pattern region of a laser colored product according to an embodiment of the invention.

FIG. 7B is a schematic structural view of a pixel of a metal color pattern layer of a pattern region according to an embodiment of the invention.

FIG. 8 is a schematic cross-sectional view of a laser colored product according to another embodiment of the invention.

FIG. 9 is a schematic cross-sectional view of a laser colored product according to another embodiment of the invention.

FIG. 10 is a schematic cross-sectional view of a laser colored product according to another embodiment of the invention.

FIG. 11A is a schematic structural top view of a pixel unit of a laser colored product according to an embodiment of the invention.

FIG. 11B is a schematic structural top view of a pixel unit of a laser colored product according to an embodiment of the invention.

FIG. 11C is a schematic structural top view of a pixel unit of a laser colored product according to an embodiment of the invention.

FIG. 12 is a schematic structural top view of a pixel unit of a laser colored product according to an embodiment of the invention.

FIG. 13 is a flow chart of a laser coloring method for coloring each of the subpixels of the pixel unit of the laser colored product according to an embodiment of the invention.

FIG. 14 is a schematic top view of pixel unit of a laser colored product according to another embodiment of the invention.

### DETAILED DESCRIPTION

In each of the embodiment of the invention, the terminology used herein is only used to describe the particular embodiments and is not for limitation. As described herein, unless the specification clearly indicates otherwise, the singular forms such as “a”, “an” and “the” are intended to include the plural forms. As described herein, the terminology “a” includes any or all combinations of one or more associated items.

In the embodiments of the invention, the terms “up”, “down”, “left”, “right”, “front” and “back” in the specification are only used to describe the relationship between one element and the other element, and these terms are only used to describe the orientation in the figures and are not used to limit the actual positions. The directions and the orientations of the devices of the figures are not limited by the reversion of the devices. The directions of D1 axis, D2 axis and D3 axis in the figures intersect perpendicularly and respectively, just as the X axis Y axis and Z axis of the Cartesian coordinate system; however, their corresponding relationships are not limited thereto.

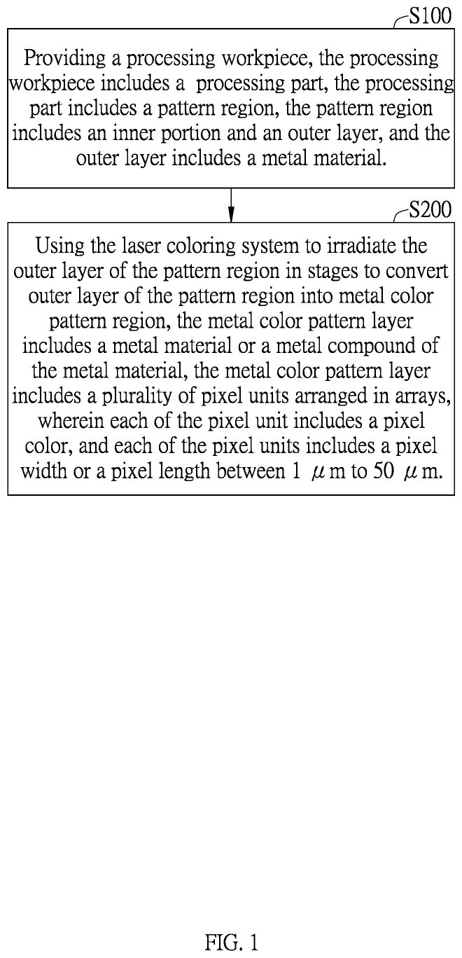

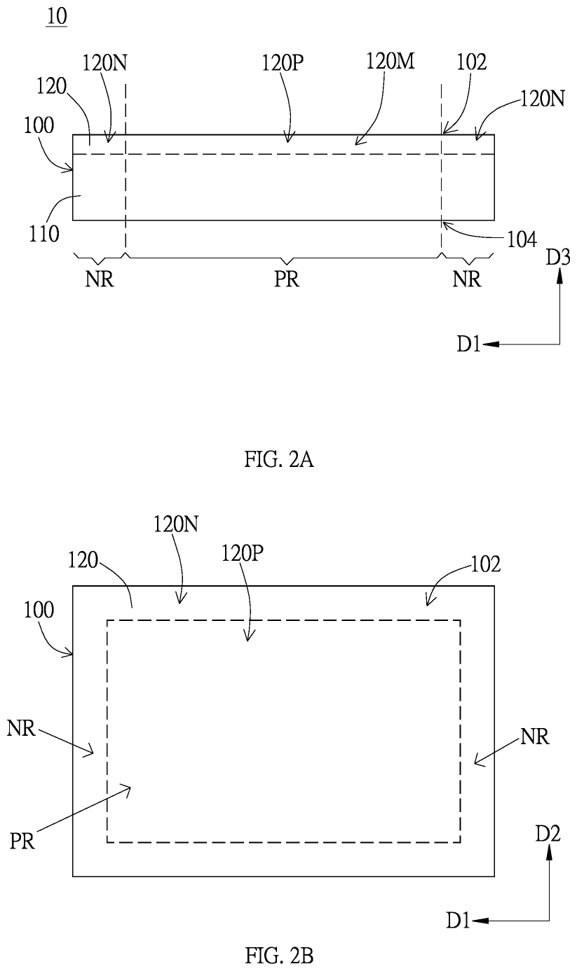

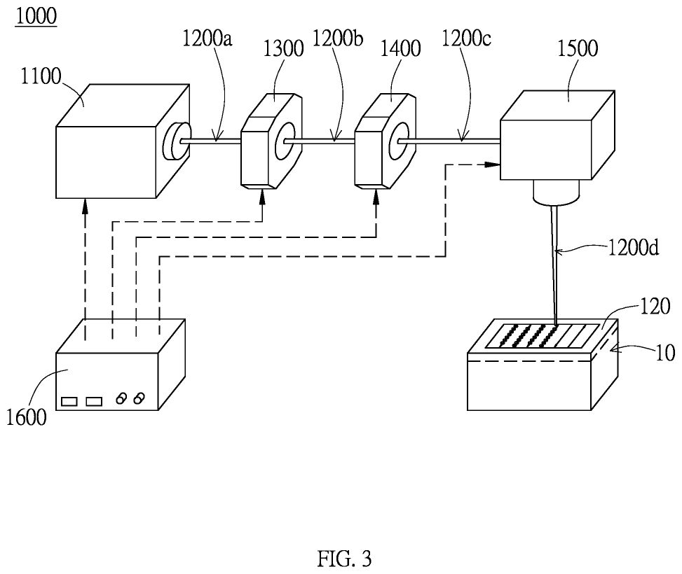

FIG. 1 is a laser coloring method according to an embodiment of the invention. FIG. 2A and FIG. 2B are a schematic cross-sectional view and a schematic top view of a processing workpiece according to an embodiment of the invention. FIG. 3 is a schematic structural view of a laser coloring system according to an embodiment of the invention. Please refer to FIG. 1 to FIG. 3. In order to highlight technologies and advantages of the invention, sizes, scales and structures in the figures will be suitably adjusted so that the purpose and the advantages of the invention can be more easily understood. The laser coloring system 1000 of the invention is only used as an example and is not represented in actual sizes and configurations. People skilled in the art can suitably modify the structural design of the laser coloring system 1000 without departing from the spirit and scope of the invention, and the effect of the invention can also be achieved.

Please refer to FIG. 1, FIG. 2A, FIG. 2B and FIG. 3. First, a processing workpiece 10 is provided (step S100). The processing workpiece 10 includes at least a processing part 100, and the processing part includes an inner portion 110 and an outer layer 120. The processing part 100 includes a pattern region PR. The pattern region PR of the processing part 100 includes an inner portion 110 and an outer layer 120P, and the outer portion 120P of the pattern region PR includes a metal material 120M. A non-pattern region NR may be optionally disposed in the periphery of the pattern region PR. The non-pattern region NR of the processing part 100 can also include part of the inner portion 110 and an outer layer 120N, and the outer layer 120N of the non-pattern region NR can also include the metal material 120M, and the invention is not limited thereto. In an embodiment, for example, the processing workpiece 10 is a metal plate which includes a first surface 102 and an opposite second surface 104. The metal plate includes the flat first surface 102 which is suitable for laser coloring process and has superior processability. In the embodiment, the outer layer 120 of the processing part 100 is composed of the metal material 120M, the metal material 120M may be stainless steel, titanium, aluminum, iron, silver, gold or the alloy thereof or any combination thereof, but not limited thereto. The metal material 120M can also be made of other suitable metal material or alloy. The inner portion 110 of the processing part 100 can be made of the same or different metal material as the outer layer 120. In a modified embodiment, the inner portion 110 of the processing part 100 can be made of a different material than the outer layer 120. The outer layer 120 may be made of, for example, a metal material 120M, and the inner portion 110 may be made of, for example, a ceramic material, glass material, plastic material or a combination thereof, and is not limited thereto. The outer layer 120 may be, for example, a metal film of thickness T preferably between 1 μm to 1000 μm for a superior processing effect. However, the thickness is not limited to the above range; thickness which is thinner or thicker can also be used. In another embodiment, the processing workpiece 10 is not limited to a metal plate or a processing workpiece with a flat surface; a processing workpiece with a curved surface is also suitable. The processing workpiece 10 can also be the case of an electronic device, a component of a bicycle or a wheel of a car, and the invention is not limited thereto Besides the processing part 100, the processing workpiece 10 can also be a combination of other components which form a complex processing workpiece. An example would be an electronic device which has been fully assembled. Laser coloring can be performed on the case of a device which has been fully assembled, and the laser coloring process performed on the processing part 100 by the laser coloring system 1000 would not be affected.

Please refer to FIG. 1 to FIG. 3. Before performing a subsequent laser coloring process, cleaning may be optionally performed on the processing workpiece 10 followed by drying to ensure that there is no residue on the surface of the processing workpiece 10, so that the subsequent laser coloring process will not be affected. Since the processing workpiece 10 may have been touched by human hand or placed in an environment that had ambient dust, grease, dust or other residue may remain on the surface of the processing part 100. The residue would absorb laser energy during the laser coloring process and cause color difference from laser coloring and affect the pattern display effect, resulting in defects in the product. Cleaning may be wet cleaning, dry cleaning or other suitable cleaning process to ensure the surface cleanliness of the processing part 100, but the invention is not limited thereto.

Please refer to FIG. 1 to FIG. 3. Before performing a subsequent laser coloring process, metal glossiness modification may be optionally performed on the processing workpiece 10. By adjusting the laser parameters and irradiating the whole or part of the outer layer 120 of the processing workpiece 10, the outer layer 120 may be rendered in various gloss levels such as flat, satin, semigloss, gloss or matte, but the invention is not limited thereto. Then a laser coloring process is performed, for example, to produce the same color with different levels of glossiness. In a modified embodiment, the laser coloring process can be performed first and have the glossiness adjusted later. In another modified embodiment, the parameters of glossiness adjustment can also be integrated into the parameters of the laser coloring process to simplify the production process.

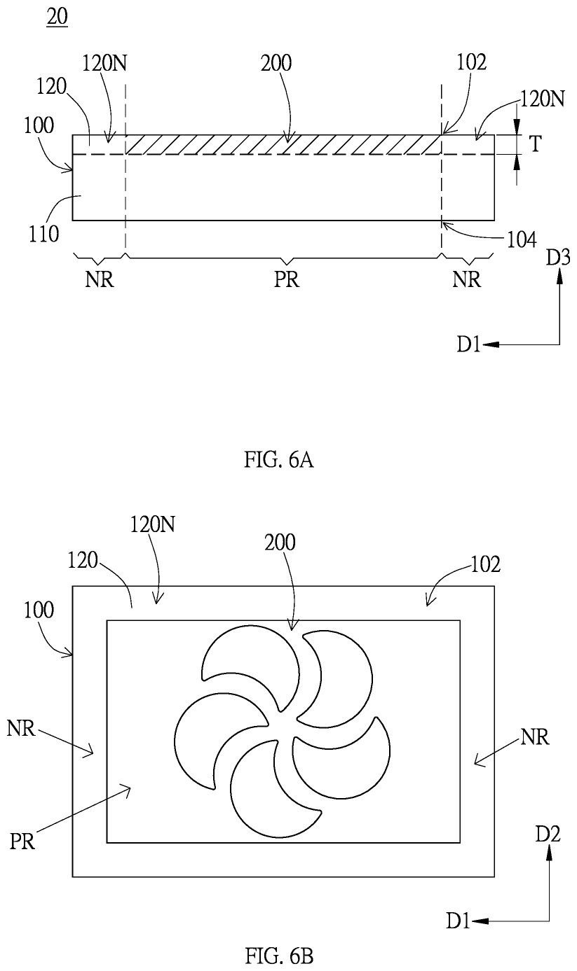

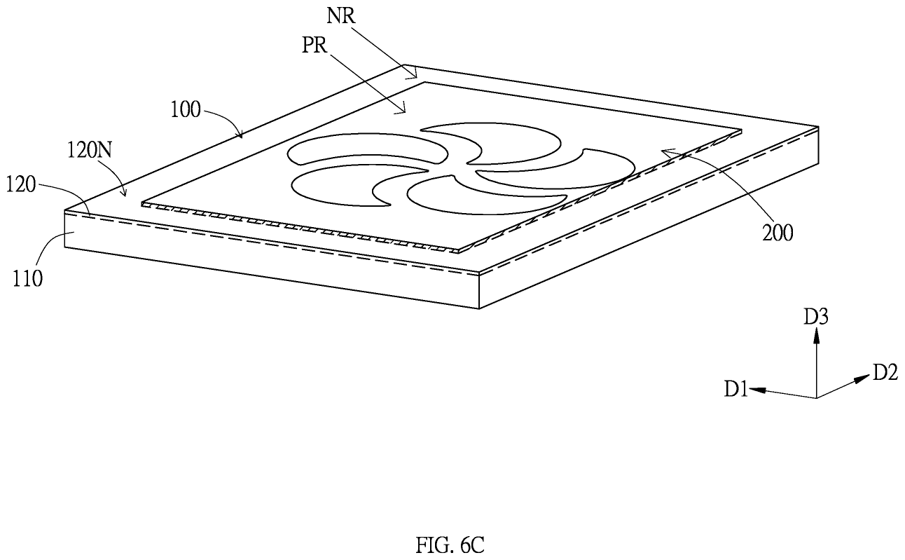

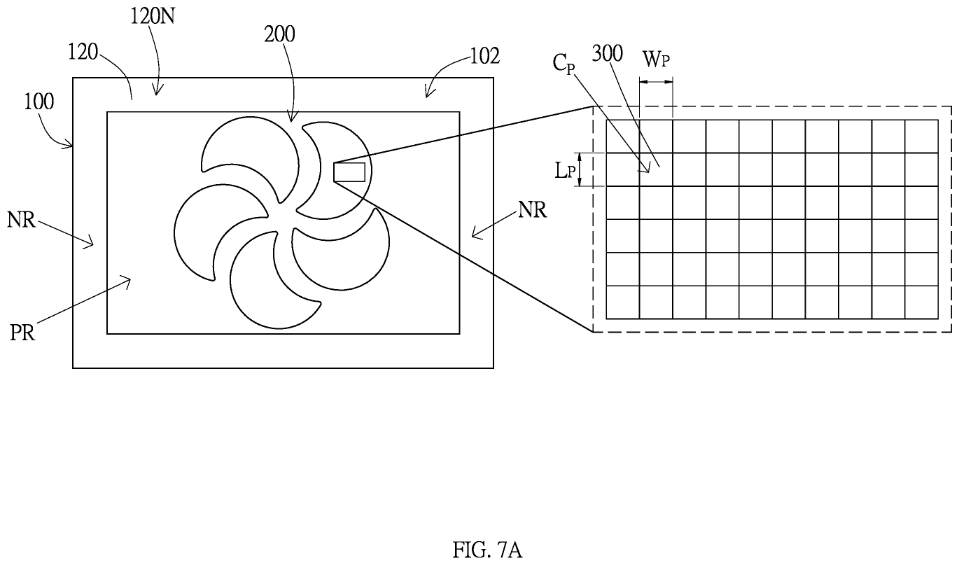

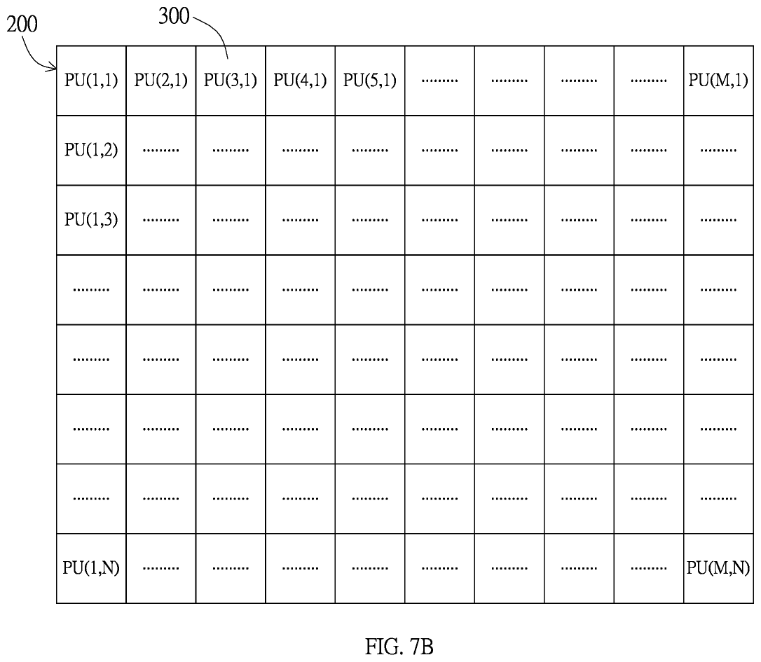

Please refer to FIG. 1 to FIG. 3. Using the laser coloring system 1000, the outer layer 120P of the pattern region PR is irradiated in stages to convert the outer layer 120P of pattern region PR into a metal color pattern layer 200 as shown in FIG. 6A to FIG. 6C. The metal color pattern layer 200 includes a metal material 120M or a metal compound 120MC of metal materials. The metal color pattern layer 200 includes a plurality of pixel units 300 arranged in arrays as shown in FIG. 7A and FIG. 7B, wherein each of the pixel units 300 has a pixel color C_{P}, and each of the pixel units 300 has a pixel width or a pixel length between 1 μm to 500 μm (Step S200). The predetermined color pattern can be calculated by a computer or other suitable calculating tools to convert it to programs or parameters of the laser coloring system 1000. The programs or parameters are then loaded into the laser coloring system 1000 to irradiate the outer layer 120P of the pattern region PR in stages. To form the required colors on the metal color pattern layer 200, the laser coloring system 1000 can be operated in an air atmosphere or a specific atmosphere such as helium (He), argon (Ar), nitrogen (N₂) or oxygen (O₂). Depending on the laser irradiation conditions and ambient atmosphere, a metal material 120M or a metal compound 120MC of metal materials with predetermined colors may be formed in the metal color pattern layer 200. The metal compound 120MC may be, for example, metal oxynitride, metal oxide or metal nitride. The metal laser coloring system 1000 can precisely control the size and color of each of the pixel units 300 up to 1 μm. As such, each of the unit pixels 300 can precisely show the predetermined position and color.

Please refer to FIG. 3. In this embodiment, the laser coloring system 1000 is used as an example, and the present invention is not limited thereto. The laser coloring system 1000 includes at least a laser source 1100 such as a pulse laser or a continuous-wave laser. For laser source 1100, different laser sources such as solid-state laser, semiconductor laser, gas laser or liquid laser may be used. Laser source 1100 can be yttrium aluminum garnet (YAG) laser, neodymium-doped yttrium aluminum garnet (Nd:YAG) laser, aluminum gallium arsenide (AlGaAs) laser, indium gallium arsenide phosphide laser, diode-pumped solid-state laser or carbon dioxide (CO₂) laser, but it is not limited thereto A fiber laser may also be used if necessary, wherein the fiber laser uses fiber (not shown) as a medium to increase photoelectric conversion efficiency and adjust the laser power and output quality. A pulse laser source 1100 may be a laser with different laser pulse width such as nano-second laser, pico-second laser or femto-second laser to obtain better laser peak power. Laser beam 1200a irradiated from laser source 1100 can be optionally controlled by a shutter 1300 as a switch of laser beam 1200a, i.e., controlling by whether the beam passes or not. The switch frequency of shutter 1300 can be controlled, and the time of laser beam 1200a passing through shutter 1300 can also be controlled. Laser beam 1200b passing through shutter 1300 can optionally be attenuated by a variable attenuator 1400 to adjust the power of the output laser beam 1200c. By optionally using a scanning system 1500, the outer layer 120P of pattern region PR of processing workpiece 10 can be quickly irradiated and scanned in small regions to convert the outer layer 120P of pattern region PR to a metal color pattern layer 200. The laser coloring system 1000 further includes a control system 1600 electrically connected to laser source 1100, shutter 1300, variable attenuator 1400 and scanning system 1500 to provide electricity and control these elements. Laser source 1100 can control the output time of laser beam 1200a by using the control system 1600. Wherein laser source 1100, shutter 1300, variable attenuator 1400, scanning system 1500 and control system 1600 are preferably digital systems. For example, with a clock period of 10⁻⁶ s (μs) or 1⁻⁹ s (ns) controlled by digital signals, a digital system can accurately output up to 10¹ to 10⁶ laser spots per second, but the invention is not limited thereto and can be adjusted according to production requirements. Thus, high resolution products can be produced, and the production rate could be very high.

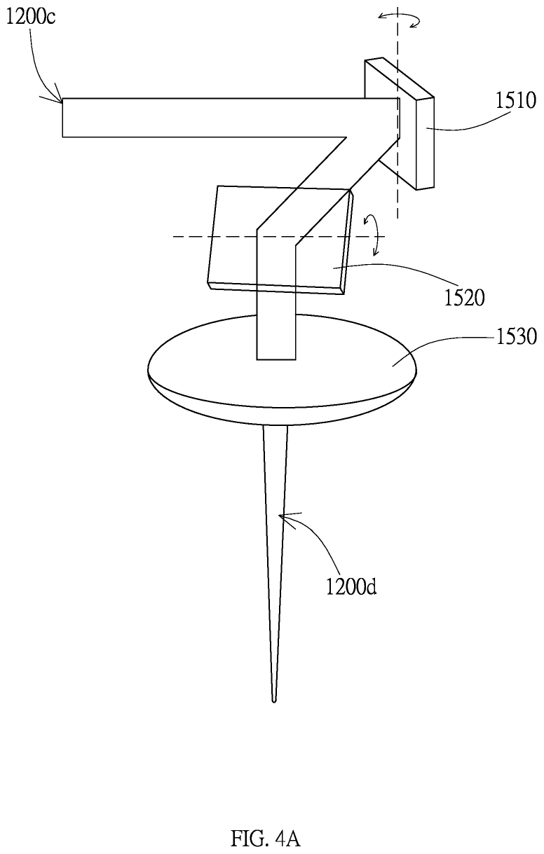

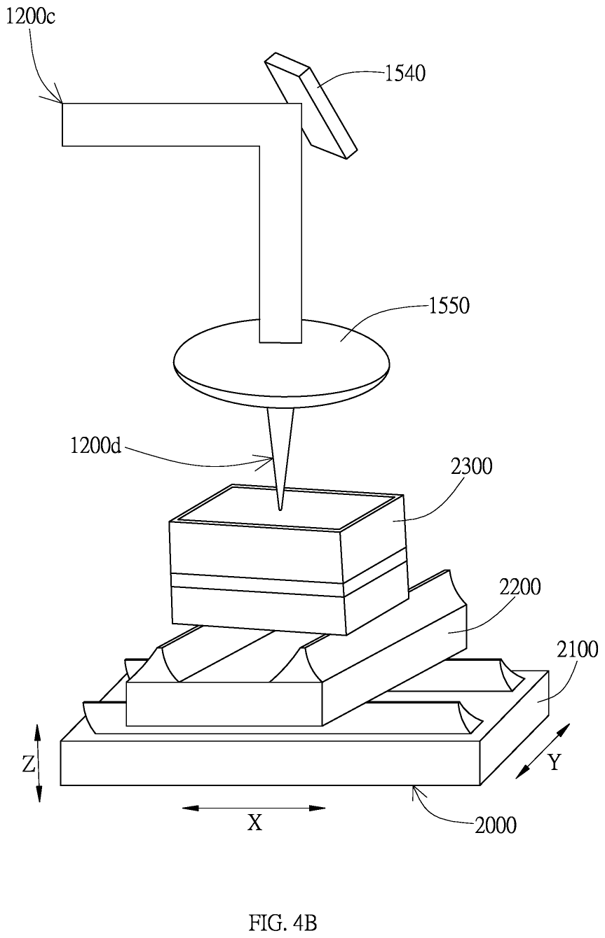

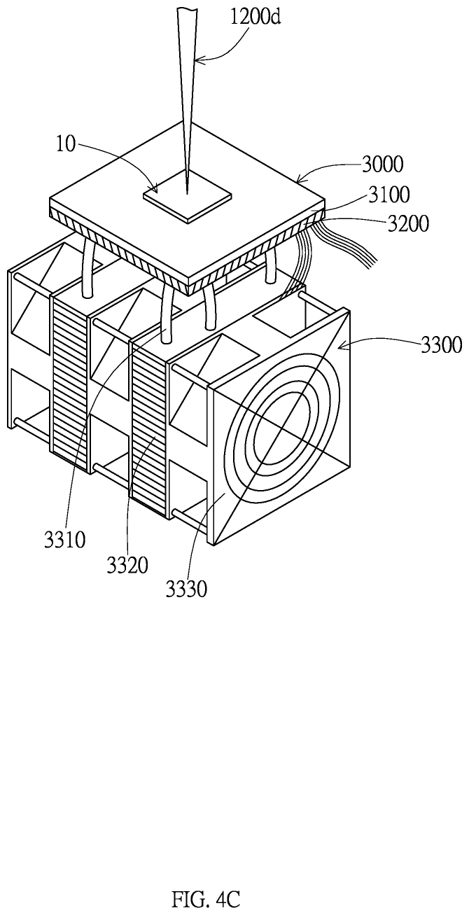

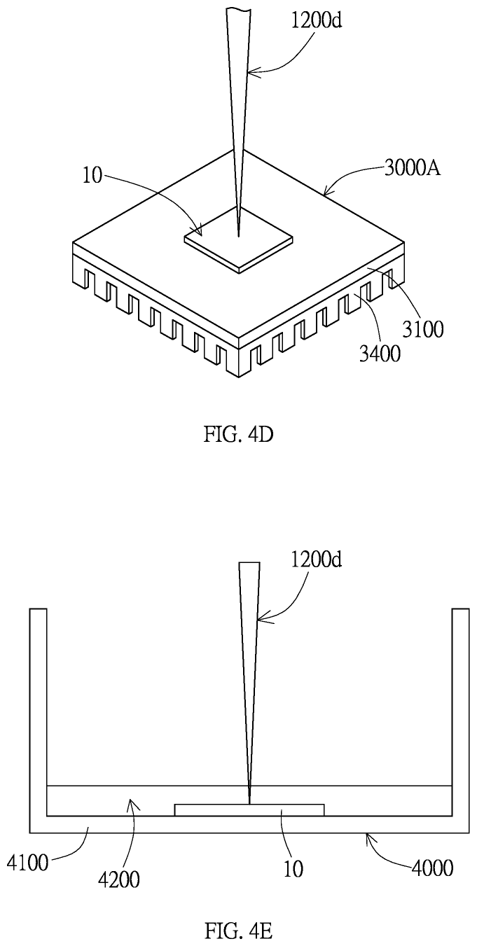

FIG. 4A is a schematic stereoscopic structural view of a scanning system according to an embodiment of the invention. FIG. 4B is a schematic stereoscopic structural view of a processing platform according to an embodiment of the invention. Please refer to FIG. 3 and FIG. 4A. The scanning system 1500 receives and reflects the laser beam 1200c to the outer layer 120 of the pattern region PR of the processing workpiece 10, irradiating in stages the laser beam 1200d on the outer layer 120P of pattern region PR, and converting the outer layer 120P of pattern region PR to a metal color pattern layer 200. The scanning system 1500 can be a galvanometer which includes a first laser scanning mirror 1510 and a second laser scanning mirror 1520 to accurately scan along an XY plane. In addition, the scanning system 1500 can also collocate a f-theta lens 1530 to accurately focus the laser beam 1200d to the outer layer 120 of the processing workpiece 10 so that laser focus deviation can be decreased and product imperfection caused by color cast due to the scanning angle can be decreased. The first scanning mirror 1510 and second scanning mirror 1520 are preferably digital scanning mirrors in order to accurately control the deflection angle of the laser scanning mirrors so that fast and accurate scanning can be achieved. Using an f-theta lens 1530 together with the digital laser scanning mirrors can accurately control the irradiation position of laser beam 1200d on the outer layer 120 with an accuracy up to 1 μm, which is suitable for producing high resolution products in small-scale.

Please refer to FIG. 4B. The processing workpiece 10 can be placed on a multi-axis processing platform 2000, and the processing workpiece 10 can be fixed on the multi-axis processing platform 2000 by a suction system or other suitable systems. Besides using the above scanning system 1500 for scanning, the high accuracy multi-axis processing platform 2000 can also accurately move on the processing workpiece 10 along the XY plane to accurately control the irradiation position of laser beam 1200d on the outer layer 120, so as to produce high resolution products in large-scale. Multi-axis processing platform 2000 can be an XY dual-axis processing platform, XYZ vertical tri-axis processing platform or XYZ gantry tri-axis processing platform, but the invention is not limited thereto Multi-axis processing platform 2000 includes at least a first slide rail 2100, a second slide rail 2200 and a work platform 2300. First slide rail 2100 and second slide rail 2200 are preferably linear slide rails, or linear motors collocated with ball screws to control movement, so that the horizontal positioning of work platform 2300 can be accurately controlled, and the accuracy of the moving position can be up to 1 μm. If the processing workpiece 10 is a curved workpiece and requires vertical movement along the Z axis the laser coloring system 1000 can move along the vertical direction by, for example, a vertical axis slide rail (not shown) or the work platform 2300 can move vertically to change the focus position. Multi-axis processing platform 2000 can collocate with a fixed-type reflector 1540 and a fixed-type focus lens 1550 to control the laser coloring position. Furthermore, multi-axis processing platform 2000 can also collocate with first laser scanning mirror 1510, second scanning mirror 1520 and f-theta lens 1530 of scanning system 1500 to perform accurate and large-scale scanning, so as to produce high-resolution and large-scale color patterns.

FIG. 4C is a schematic stereoscopic structural view of a heat dissipating platform according to an embodiment of the invention. Please refer to FIG. 3, FIG. 4A and FIG. 4C. The invention can also use a heat dissipating processing system 3000 to improve heat dissipation of the processing workpiece 10. When the laser coloring system 1000 irradiates the processing workpiece 10, the outer layer 120 of the processing workpiece 10 absorbs part of the energy of the laser beam 1200d. Thus, if heat dissipation is not enough, laser beam 1200d will cause heat to accumulate in a local area and the local area won't form the predetermined structure and color, resulting in uneven structure and the imperfection of color cast or uneven color in the local area. The heat dissipating processing system 3000 of the invention includes at least a heat dissipating platform 3100 and a thermo-electric cooling chip 3200. The processing workpiece 10 is placed on the heat dissipating platform 3100, and the thermo-electric cooling chip 3200 is attached under the heat dissipating platform 3100. The semiconductor structure of the thermo-electric cooling chip 3200 is used to bring the excess heat of the processing workpiece 10 and the heat dissipating platform 3100 by the flow of the current after the thermo-electric cooling chip 3200 is energized, so as to achieve a quick heat dissipation effect. The thermo-electric cooling chip 3200 can improve the heat dissipation efficiency and heat dissipation environment of the laser coloring process, so that the color obtained after laser irradiation is more uniform. In addition, a heat dissipation structure 3300 such as a heat dissipating pipe 3310, heat dissipating fin 3320 or heat dissipating fan 3330 can be optionally disposed under the thermo-electric cooling chip 3200 to further improve heat dissipation efficiency, but the invention is not limited thereto. If necessary, a temperature sensing chip (not shown) can also be installed to accurately control the temperature of the processing workpiece 10 and the heat dissipating platform 3100.

FIG. 4D is a schematic stereoscopic structural view of a heat dissipating platform according to an embodiment of the invention. Please refer to FIG. 3, FIG. 4A and FIG. 4D. Besides the above-mentioned heat dissipating processing system 3000, the invention can also use a heat dissipating processing system 3000A. In the embodiment, the heat dissipating processing system 3000A of the invention includes at least the heat dissipating platform 3100 and a passive heat dissipating fin (passive heat sink) 3400. The processing workpiece 10 can be placed on the heat dissipating platform 3100, and the passive heat dissipating fin 3400 is attached under the heat dissipating platform 3100. When the laser coloring system 1000 irradiates the processing workpiece 10, the heat accumulated in a local area by the laser beam 1200d can be quickly and uniformly dissipated by the passive heat dissipating fin 3400, so as to avoid the imperfection of color cast or uneven color in the local area. A thermo-electric cooling chip 3200 (not shown) can be optionally disposed between the heat dissipating platform 3100 and the passive heat dissipating fin to improve heat dissipation efficiency. In addition, a heat dissipating fan can be optionally disposed under the passive heat dissipating fin 3400 to further improve heat dissipation efficiency, but the invention is not limited thereto.

FIG. 4E is a schematic stereoscopic structural view of a processing groove according to an embodiment of the invention. Please refer to FIG. 3, FIG. 4A and FIG. 4E. The invention can also use a heat dissipating processing system 4000 to improve heat dissipation of the processing workpiece 10. The heat dissipating processing system 4000 of the invention includes a processing groove 4100 and a solution 4200. The processing workpiece 10 is disposed in the processing groove 4100 as shown in FIG. 4E. The solution 4200 is added into the processing groove 4100 to surround or cover the processing workpiece 10. The solution 4200 can be pure water or salt water to quickly achieve the heat dissipation effect, but the invention is not limited thereto. In an embodiment, having the solution 4200 cover the processing workpiece 10 can achieve a better and quicker heat dissipation effect. In addition, if the solution 4200 covers the processing workpiece 10, it is preferred to consider using a solution with low or non-absorption to laser beam 1200d for the solution 4200, so as to decrease the solution 4200's influence on the laser coloring process. Furthermore, in a modified embodiment, oxygen gas can be optionally added into the solution 4200 to increase oxygen content of the solution 4200, so as to improve the generation of metal oxides in the laser coloring structure.

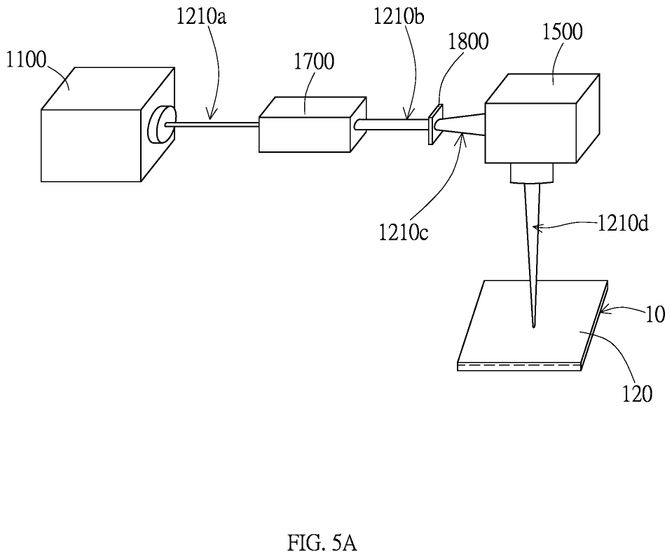

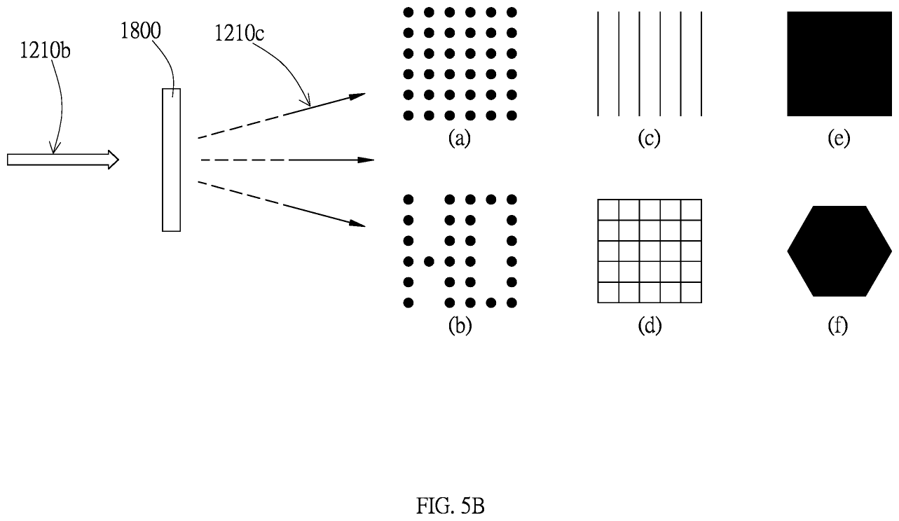

FIG. 5A is a schematic structural view of a laser coloring system according to another embodiment of the invention. FIG. 5B is a schematic view of a laser speckle using a diffraction optical element according to another embodiment of the invention. Most of the laser speckle of the laser output has a circle shape, the optical elements can be optionally used to modify the size of the shape of the required laser speckle. Please refer to FIG. 5A. The diameter or the equivalent diameter of a laser beam 1210a output from the laser source 1100 through a shutter (not shown) can be optionally modified by a beam expander 1700. For example, the laser beam 1210b modified by the beam expander 1700 has a larger diameter. In addition, the pattern of the laser speckle can be optionally modified by a diffractive optical element 1800. The laser beam 1210b can be output as laser beam 1210c through the diffractive optical element 1800 with different laser speckle pattern.

Please refer to FIG. 5B. The laser beam 1210c can have a laser speckle pattern of, for example, a 6×6 spot array as shown in pattern (a). The laser beam 1210c can have a laser speckle pattern of, for example, spots with random dispersion as shown in pattern (b). The laser beam 1210c can have a laser speckle pattern of, for example, parallel lines as shown in pattern (c). The laser beam 1210c can have a laser speckle pattern of, for example, a net shape as shown in pattern (d). The laser beam 1210c can have a laser speckle pattern of, for example, a quadrilateral shape as shown in pattern (e). The laser beam 1210c can have a laser speckle pattern of, for example, a hexagon as shown in pattern (f). The patterns (a) to (f) are only examples and the laser speckle patterns of the laser beam 1210c are not limited thereto Please refer to FIG. 5A and FIG. 5B, the laser beam 1210d, which is the laser beam 1210c guided through the scanning system 1500, has the same laser speckle pattern as the laser beam 1210c. The laser beam 1210d is preferred for producing the pixel unit 300 of the metal color pattern layer 200 after pattern modification, so that each of the pixel units 300 can be produced more quickly. In the laser coloring process, the diffractive optical element 1800 can be used to decrease thermal effect of each of the pixel units 300 to optimize coloring efficiency.

FIG. 6A is a schematic cross-sectional view of a laser colored product according to an embodiment of the invention. FIG. 6B is a schematic top view of a laser colored product according to an embodiment of the invention. FIG. 6C is a schematic stereoscopic structural view of a laser colored product according to an embodiment of the invention. Please refer to FIG. 6A, FIG. 6B and FIG. 6C. In the embodiment, a metal plate is used as an example of the processing workpiece 10, but the invention is not limited thereto. The processing part 100 of the processing workpiece 10 is colored by the laser coloring system 1000, and the outer layer 120P of the pattern region PR is converted to the metal color pattern layer 200. The outer layer 120N of the non-pattern region NR still remains the original color if the processing part 100 has a non-pattern region NR. The outer layer 120P of the pattern region PR is preferred to have a thickness T that is sufficient for the laser coloring system 1000 to perform coloring. The microstructure of the outer layer 120P of the pattern region PR is converted to the metal color pattern layer 200 after the laser coloring process is performed, so that ambient incident light shows the required color after reflection.

FIG. 7A is a partially enlarged schematic diagram of a local area of a pattern region of a laser colored product according to an embodiment of the invention. FIG. 7B is a schematic structural view of a pixel of a metal color pattern layer of a pattern region according to an embodiment of the invention. Please refer to FIG. 7A and FIG. 7B. The laser colored product 20 includes at least a processing part 100 and a metal color pattern layer 200. The processing part 100 includes an inner portion 110 and a pattern region. The metal color pattern layer 200 is disposed on the inner portion 110 of the pattern region PR, and the metal color pattern layer 200 includes a metal material 120M or a metal compound 120MC of metal materials. The metal color pattern layer 200 includes a plurality of pixel units 300 arranged in arrays. Sizes and positions of each of the pixel units 300 can be easily controlled by the laser coloring system 1000 of the invention. Each of the pixel units 300 has a pixel width W_{P} or a pixel length L_{P} between 1 μm to 500 μm. In addition, each of the pixel units 300 has an independent pixel color C_{P}. The predetermined color pattern on the processing workpiece 10 can be converted to programs or parameters to be input into the laser coloring system 1000. Please refer to FIG. 7B. For example, the predetermined color pattern can be converted into M×N (M>0, N>0) pixel units 300 according to resolution requirements, and the corresponding pixel width W_{P}, pixel length L_{P} and the laser coloring parameters correlated to the pixel color C_{P} can be computed. After loading the computed laser coloring programs or parameters, the laser coloring system 1000 can automatically perform the laser coloring process, and the processing workpiece 10 is processed and colored to a colorful laser colored product 20 with the required high resolution. In the laser coloring process, producing each of the pixel units 300 separately can decrease the thermal effect of each of the pixel units 300 and optimize coloring efficiency.

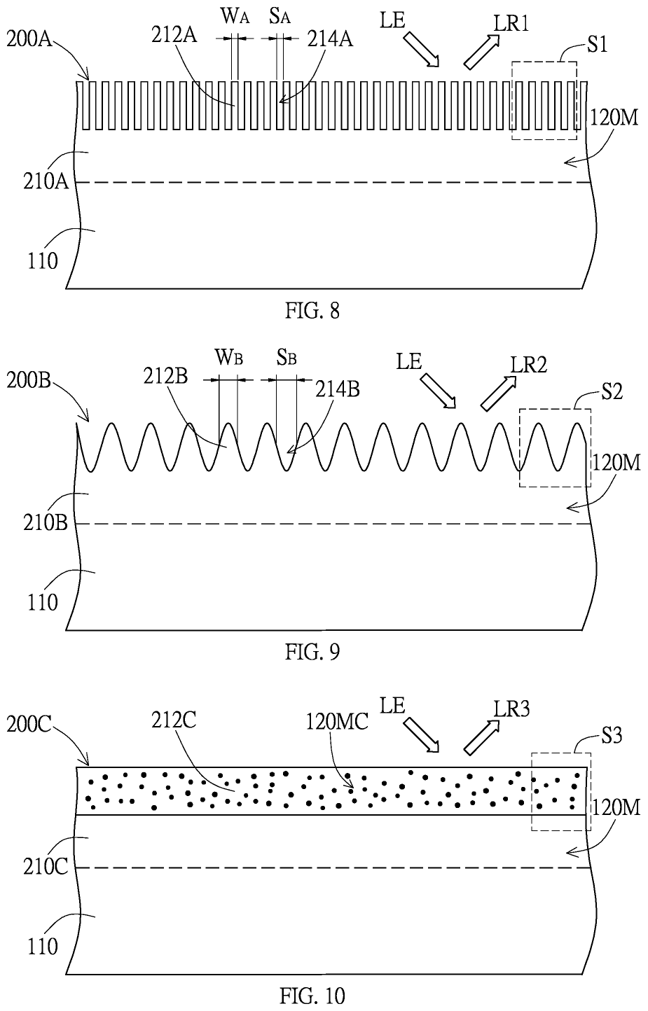

FIG. 8 is a schematic cross-sectional view of a laser colored product according to another embodiment of the invention. Before irradiating the outer layer 120P of the pattern region PR in stages by the laser coloring system 1000, a first laser irradiation program or parameter P1 is loaded to make the metal color pattern layer 200A (converted from the outer layer 120P) include a metal nanostructure S1 to reflect the ambient incident light LE and show the reflected light LR1, so as to produce plasmon colors. A bottom layer 210A can be optionally disposed between the metal nanostructure S1 and the inner portion 110, and the bottom layer 210A includes the metal material 120M. If the inner portion 110 of the processing part 100 is not made of metal materials, a bottom layer 210A with a sufficient thickness may be disposed to provide enough light reflection and decrease light transmittance, but the invention is not limited thereto. In order to form the metal nanostructure S1, the diameter of the laser beam 1200d of the laser coloring system 1000 is preferably a laser speckle with a small diameter, for example, a diameter between 1 μm to 10 μm, but the invention is not limited thereto By adjusting the transverse wave fundamental mode of the laser speckle, the energy dispersion of the laser speckle can be adjusted, and a plurality of peaks are formed in the laser speckle to easily form the metal nanostructure S1 that is required. The metal nanostructure S1 may include, for example, a columnar nanostructure 212A and a nanogap 214A disposed within the columnar nanostructure 212A, and the equivalent columnar width W_{A} and the equivalent gap width SA are preferably nano grade, such as between 1 nm to 1000 nm, but the invention is not limited thereto. The nano grade metal particles (metal nanostructure S1) are irradiated by ambient light to cause surface plasmon resonance (SPR) and excite light, so the required plasmon color can be produced. By adjusting the density among the columnar nanostructures to change the resonance conditions, the required pixel color C_{P} of each of the pixel units 300 can be reflected.

FIG. 9 is a schematic cross-sectional view of a laser colored product according to another embodiment of the invention. Please refer to FIG. 9. Before irradiating the outer layer 120P of the pattern region PR in stages by the laser coloring system 1000, a second laser irradiating program or parameter P2 is loaded to make the metal color pattern layer 200B (converted from the outer layer 120P) include a laser induced periodic surface structure (LIPSS) S2 to reflect the ambient incident light LE and show the reflected light LR2, thereby forming structural colors. A bottom layer 210B may be optionally disposed between the LIPPS microstructure S2 and the inner portion 110, and the bottom layer 210B includes the metal material 120M. If the inner portion 110 of the processing part 100 is not made of metal materials, a bottom layer 210B with a sufficient thickness may be disposed to provide enough light reflection and decrease light transmittance, but the invention is not limited thereto By scanning periodically and parallelly in the same direction or back and forth, the laser beam 1200d of the laser coloring system can form periodical columnar structures 212B and the groove gaps 214B on the outer layer 120P of the processing workpiece 10, and the equivalent columnar width WB and the equivalent gap width SB range between 0.01 μm to 100 μm, but the invention is not limited thereto. The periodical microstructures will produce an effect similar to the grating effect. When the ambient light LE irradiates into the LIPSS microstructure S2, diffraction and interference will occur, thereby forming the required structural color. The pixel color C_{P} of each of the pixel units 300 can be reflected by adjusting the density among the LIPPS microstructure S2 to change the interference condition.

FIG. 10 is a schematic cross-sectional view of a laser colored product according to another embodiment of the invention. Please refer to FIG. 10. Before irradiating the outer layer 120P of the pattern region PR in stages by the laser coloring system 1000, a third laser irradiating program or parameter P3 is loaded to make the metal color pattern layer 200C (converted from the outer layer 120P) include a film structure S3 of the metal compound film 212C to reflect the ambient incident light LE and show the reflected light LR3, thereby forming film interference colors. A bottom layer 210C may be optionally disposed between the film structure S3 and the inner portion 110, and the bottom layer 210C includes the metal material 120M. If the inner portion 110 of the processing part 100 is not made of metal materials, a bottom layer 210C with a sufficient thickness may be disposed to provide enough light reflection and decrease light transmittance, but the invention is not limited thereto. The laser coloring system 1000 can operate in the air or in an enclosed atmosphere of oxygen or nitrogen to convert the metal material 120M into its metal compound 120MC such as metal oxynitride, metal oxide or metal nitride. The metal compound film 212C has a thickness t between 1 nm to 1000 nm, but the invention is not limited thereto. The thickness can be thicker and adjusted according to the wavelength of the required color. Using the optical path difference created by the incident light LE and reflected between the upper surface and the bottom surface of the metal compound film 212C, film interference is produced to obtain the required film interference colors. By adjusting the thickness t of the metal compound film 212C in consideration of the original metal color of the metal material 120M of the outer layer 120P and the refractive index and the absorption band of the metal compound film 212C, the colors formed by the film interference can be calculated, thereby reflecting the required pixel color C_{P} of each of the pixel units 300.

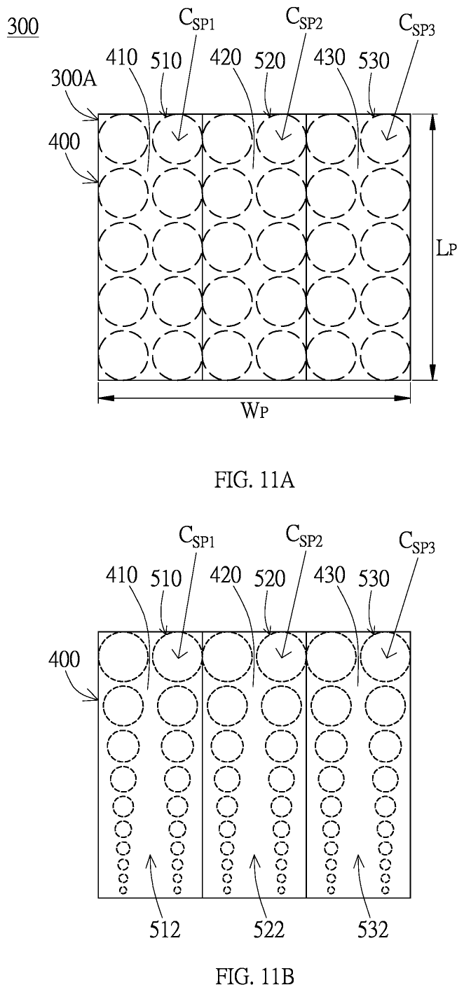

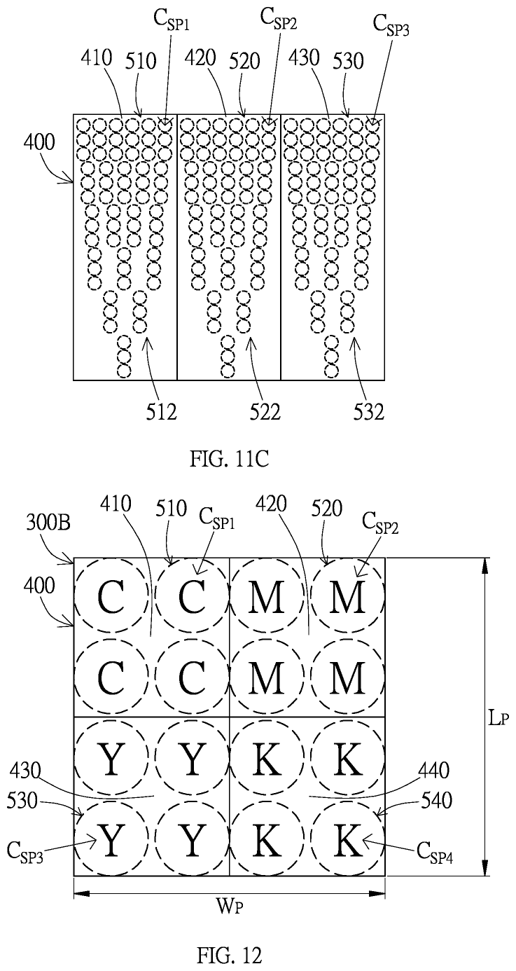

FIG. 11A is a schematic structural top view of a pixel unit of a laser colored product according to an embodiment of the invention. Please refer to FIG. 11A. Although the number of the pixel colors C_{P} obtained from the above three methods are limited, if the number of colors can meet the number of colors needed for the metal color pattern layer 200, each of the pixel units 300 can be produced directly. On the contrary, if the metal color pattern layer 200 still needs a higher number of colors, a plurality of subpixels 400 can be designed within each of the pixel units 300. The plurality of the subpixels 400 are mixed to provide a higher number of colors. Referring to FIG. 11A, the pixel unit 300 can be designed as, for example, pixel unit 300A. Each of the pixel units includes at least two subpixels 400 and more preferred three subpixels 400, and each of the subpixels 400 includes a subpixel color C_{SP}. Each of the subpixels 400 includes a first subpixel 410, a second subpixel 420 and a third subpixel 430. The first subpixel 410 includes a first subpixel color C_{SP1}; the second subpixel 420 includes a second subpixel color C_{SP2}; and the third subpixel 430 includes a third subpixel color C_{SP3}. The three subpixels 400 can be the three primary colors of CMY. For example, the first subpixel color C_{SP1} can be cyan (C), the second subpixel color C_{SP2} can be magenta (M), and the third subpixel color C_{SP3} can be yellow (Y), but the invention is not limited thereto. The three primary colors of RGB can also be used to mix colors. Using the three primary colors of CMY, more required colors can be mixed and a higher number of colors can be provided. In an embodiment, the invention can be composed of only two colors such as the first subpixel color C_{SP1} of the first subpixel 410 and the second subpixel color C_{SP2} of the second subpixel 420. Or, the invention may also be composed of more colors such as the six colors of RGBCMY, and the invention is not limited thereto. The three subpixels 400 are not limited to being horizontally arranged, as shown in FIG. 11A. The three subpixels 400 can also be vertically arranged after a 90° rotation. The three subpixels 400 are not limited to rectangular shapes but can be square, triangular, hexagonal or other shapes, and the three subpixels 400 can be arranged in various ways to obtain a uniform color display effect.

Please refer to FIG. 11A. In this embodiment, each of the pixel units 300A is composed of subpixels 400, and the subpixel color C_{SP} of each of the subpixels 400 is a fixed color such as the three primary colors. Thus, when the predetermined color pattern on the processing workpiece 10 is converted, the color pattern is calculated to the subpixel 400, and, according to the predetermined number of colors, the color scale of each subpixel 400 is simulated. Through a computer or computing system, the color pattern is converted to programs or parameters required by the laser coloring system 1000. Since the subpixels 400 are used for color mixing, each subpixel color C_{SP} of each of the subpixels 400 is a fixed color, and therefore laser irradiating parameters for only two or three or less colors are necessary, thereby speeding up the production of each subpixel. Mixing colors using three primary colors can produce a sufficient number of colors according to the number of color scales. If necessary, the ratio of the areas of the first subpixel 410, the second subpixel 420 and the third subpixel 430 can be adjusted to obtain different color mixing effects, so as to produce more continuous color designs.

Please refer to FIG. 3 and FIG. 11A. The laser coloring system 1000 is used to perform the laser coloring process according to for example, one of the three methods in the aforementioned FIG. 8 to FIG. 10. With the required parameters adjusted, a plurality of the first laser points 510 within the first sub pixel 410 are irradiated, so that the first subpixel 410 is converted to the required first subpixel color C_{SP1}. The first laser points 510 can be nonoverlapping with each other, or one or more adjacent first laser points 510 can overlap with each other (not shown). The overlapped first laser points 510 can be scanned in a moving manner to increase the display effect of the first subpixel color C_{SP1}. Then, adjust the required parameters and move the irradiation position and irradiate the plurality of second laser points 520 within the second subpixel 420 to convert the required second pixel color C_{SP2}. The second laser points 520 can be nonoverlapping with each other, or one or more adjacent second laser points 520 can overlap with each other (not shown). The overlapped second laser points 520 can be scanned in a moving manner to increase the display effect of the second subpixel color C_{SP2}. Next, adjust the required parameters and move the irradiation position and irradiate the plurality of third laser points 530 within the third subpixel 430 to convert the required third pixel color C_{SP3}. The third laser points 530 can be nonoverlapping with each other, or one or more adjacent third laser points 530 can overlap with each other (not shown). The overlapped third laser points 530 can be scanned in a moving manner to increase the display effect of the third subpixel color C_{SP3}. In a modified embodiment, the first laser points 510, the second laser points 520 and the third laser points 530 are uniformly dispersed in the pixel unit 300A to enhance the uniform mixing of the first subpixel color C_{SP1}, the second subpixel color C_{SP2} and the third subpixel color C_{SP3}.

FIG. 11B is a schematic structural top view of a pixel unit of a laser colored product according to another embodiment of the invention. As shown in FIG. 11B, besides adjusting the area ratio, for the first subpixel 410, the number and sizes of the first laser points 510 can be adjusted to adjust the color scales of the first subpixel color C_{SP1}. The region inside the first subpixel 410 where the first laser points 510 are not irradiated is the first blank region 512. The first blank region 512 can keep the original metal color of the outer layer 120 or go through a blackening treatment to become black, or go through other suitable treatments. Similarly, for the second subpixel 420, the number and sizes of the second laser points 520 can be adjusted to adjust the color scales of the second subpixel color C_{SP2}. The region inside the second subpixel 420 where the second laser points 520 are not irradiated is the second blank region 522. The second blank region 522 can keep the original metal color of the outer layer 120 or go through a blackening treatment to become black, or go through other suitable treatments. Similarly, for the third subpixel 430, the number and sizes of the third laser points 530 can be adjusted to adjust the color scales of the third subpixel color C_{SP3}. The region inside the third subpixel 430 where the third laser points 530 are not irradiated is the third blank region 532. The third blank region 532 can keep the original metal color of the outer layer 120 or go through a blackening treatment to become black, or go through other suitable treatments.

FIG. 11C is a schematic structural top view of a pixel unit of a laser colored product according to an embodiment of the invention. By adjusting the number and dispersion density of the first laser points 510, the second laser points 520 and the third laser points 530 in the first subpixel 410, the second subpixel 420 and the third subpixel 430 respectively, the color scales of the first subpixel color C_{SP1}, the second subpixel color C_{SP2} and the third subpixel color C_{SP3} can be adjusted, as shown in FIG. 11C. The first blank region 512, the second blank region 522 and the third blank region 532, where the laser points are not irradiated, can optionally keep the original metal color of the outer layer 120 or go through a blackening treatment to become black, or go through other suitable treatments, and the invention is not limited thereto.

FIG. 12 is a schematic structural top view of a pixel unit of a laser colored product according to an embodiment of the invention. In another embodiment of the invention, the pixel unit 300 can also be designed as a pixel unit 300B with four subpixels 400. The fourth subpixel 440 which is added into the pixel unit 300B includes a fourth subpixel color C_{SP4} which is for example, black (K). Since mixing equivalent amounts of the three CMY primary colors can only produce the color of dark gray or dark brown, the use of the black fourth subpixel 440 can improve the problem of insufficient blackness and enhance the contrast. For example, the laser coloring process shown in FIG. 11A can be used to produce the first subpixel 410, the second subpixel 420 and the third subpixel 430. Then, the laser coloring system 1000 is used to perform the laser coloring process according to for example, one of the three methods in the aforementioned FIG. 8 to FIG. 10. With the required parameters adjusted, a plurality of the fourth laser points 540 within the first subpixel 440 are irradiated, so that the fourth subpixel 410 is converted to the required fourth subpixel color C_{SP4}. The fourth laser points 540 inside the fourth subpixel 440 can be nonoverlapping with each other, or one or more adjacent fourth laser points 540 can overlap with each other (not shown). The overlapped fourth laser points 540 can be scanned in a moving manner to increase the display effect of the fourth subpixel color C_{SP4}. If necessary, the ratio of the areas of the first subpixel 410, the second subpixel 420, the third subpixel 430, and the fourth subpixel 440 can be adjusted to obtain different color mixing effects, so as to produce more continuous color designs. The area ratio of the fourth subpixel 440 can also be adjusted to modify the illuminance of the colors. Please also refer to FIG. 11B, FIG. 11C and FIG. 12. The sizes, number or dispersion density of the fourth laser points 540 can be adjusted to modify the gray scale or illumination, which will not be described herein.

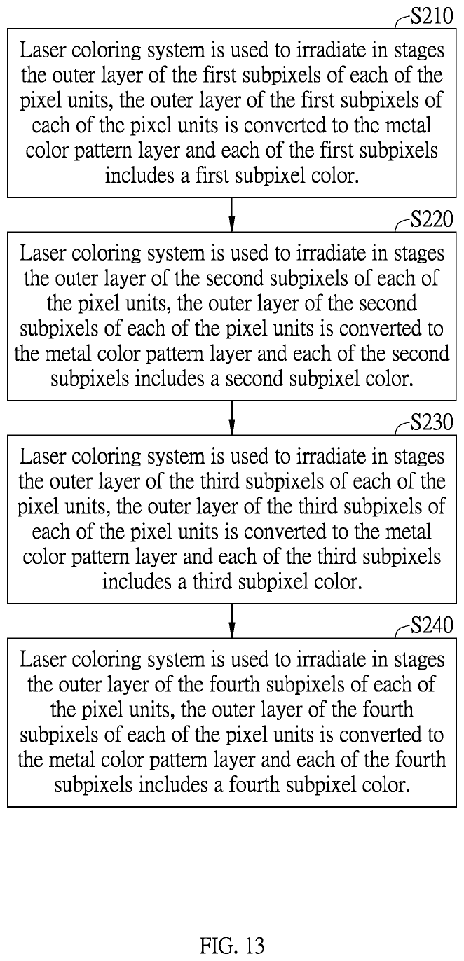

FIG. 13 is the flow chart of a laser coloring method for coloring each of the subpixels of the pixel unit of a laser colored product according to an embodiment of the invention. In the embodiment, the pixel unit 300B of FIG. 12 is used as an example, but the invention is not limited thereto Since the laser coloring system 1000 produces only a single subpixel color C_{SP4} during each step, the controlling condition of the laser coloring system 1000 can then be simplified by loading the color parameter only once per step and moving the system to the corresponding scanning position and controlling the laser irradiation switch, so that the production of the metal color pattern layer 200 may be accelerated. Please refer to FIG. 13. First, the laser coloring system 1000 loads the laser irradiation programs or parameters of the first subpixel 410, which include the color and position parameters. The laser coloring system 1000 is used to irradiate in stages the outer layer 120 of the first subpixels 410 of each of the pixel units 300B, so that the outer layer 120 of the first subpixels 410 of each of the pixel units 300B is converted to the metal color pattern layer 200, and each of the first subpixels 410 includes a first subpixel color C_{SP1} (Step S210). Please refer to FIG. 7B and FIG. 13. For example, sequentially irradiate the first subpixel 410 of the pixel unit PU (1, 1) in the first row to the first subpixel 410 of the pixel unit PU (M, 1). Then, sequentially irradiate the first subpixel 410 of the pixel unit PU (1, 2) in the second row to the first subpixel 410 of the pixel unit PU (M, 2). Furthermore, sequentially irradiate the first subpixel 410 of the third row, the fourth row . . . until the pixel unit PU (M, N) of the Nth row to finish the production of the first subpixels 410. The first subpixel color C_{SP1} may be, for example, cyan.

Please refer to FIG. 13, next, the laser coloring system loads the laser irradiation programs or parameters of the second subpixel 420, which include the color and position parameters. The laser coloring system 1000 is used to irradiate in stages the outer layer 120 of the second subpixels 420 of each of the pixel units 300B, so that the outer layer 120 of the second subpixels 420 of each of the pixel units 300B is converted to the metal color pattern layer 200 and each of the second subpixels 420 includes a second subpixel color C_{SP2} (Step S220). Please refer to FIG. 7B and FIG. 13. Sequentially irradiate the second subpixels 420 of the pixel unit PU (1, 1) in the first row to the pixel unit PU (M, N) in the Nth row to finish the production of the second subpixels 420. The second subpixel color C_{SP2} may be, for example, yellow.

Please refer to FIG. 13. Next, the laser coloring system loads the laser irradiation programs or parameters of the third subpixel 430, which include the color and position parameters. The laser coloring system 1000 is used to irradiate in stages the outer layer 120 of the third subpixels 430 of each of the pixel units 300B, so that the outer layer 120 of the third subpixels 430 of each of the pixel units 300B is converted to the metal color pattern layer 200 and each of the third subpixels 430 includes a third subpixel color C_{SP3} (Step S230). Please refer to FIG. 7B and FIG. 13. Sequentially irradiate the third subpixels 430 of the pixel unit PU (1, 1) in the first row to the pixel unit PU (M, N) in the Nth row to finish the production of the third subpixels 430. The third subpixel color C_{SP3} may be, for example, magenta.

Please refer to FIG. 13. Next, the laser coloring system 1000 loads the laser irradiation programs or parameters of the fourth subpixels 440, which include the color and position parameters. The laser coloring system 1000 is used to irradiate in stages the outer layer 120 of the fourth subpixels 440 of each of the pixel units 300B, so that the outer layer 120 of the fourth subpixels 440 of each of the pixel units 300B is converted to the metal color pattern layer 200 and each of the fourth subpixels 440 includes a fourth subpixel color C_{SP4} (Step S240). Please refer to FIG. 7B and FIG. 13. Sequentially irradiate the subpixels 440 of the pixel unit PU (1, 1) in the first row to the pixel unit PU (M, N) in the Nth row to finish the production of the fourth subpixels 440. The fourth subpixel color C_{SP4} may be, for example, black.

Using the production method of Step S210 to S 240 to produce the metal color pattern layer 200 can simplify the color controlling parameters, so that the laser coloring system 1000 can quickly and accurately produce the metal color pattern layer 200 with high resolution and a large number of colors. This production method can be used in making identification labels such as a QR code with high resolution and high contrast for easy identification and solve the problem of poor identification. The laser coloring process of the invention is relatively clean and safe. It does not use dyes, nor does it cause occupational injury for practitioners. It reduces environmental pollution and meets the requirement of modern environmental protection. Furthermore, in the laser coloring process, each of the subpixels 400 is separately produced to lower the heat effect in each of the subpixels 400, so as to optimize coloring efficiency.

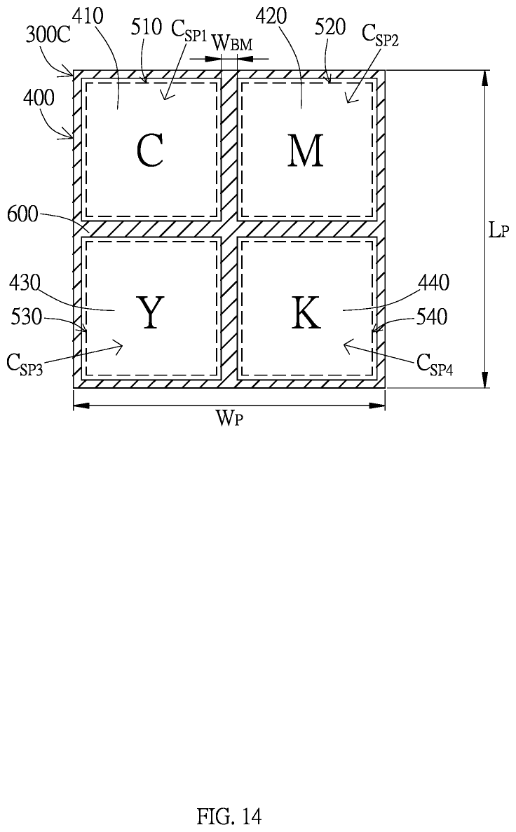

FIG. 14 is a schematic top view of a pixel unit of a laser colored product according to another embodiment of the invention. Please refer to FIG. 14. The pixel unit 300 can be designed as pixel unit 300C. Referring to FIG. 14, a black matrix 600 can be optionally added among each of the subpixels 400, so that imperfections such as light leak or color cast caused by bad mixing of colors on the edge of the subpixels 400 under a squint view (such as 45°) can be decreased. The width W_{BM} of the black matrix 600 between two adjacent subpixels 400 can be determined by referring to the pixel length L_{P} and the pixel width W_{P} of the pixel unit 300. The width W_{BM} of the black matrix 600 may be, for example, between 1 μm to 30 μm, but is not limited thereto. The color parameters of the black matrix 600 can be determined by referring to the color parameters of the black subpixels. Please refer to FIG. 5B and FIG. 14. Each black matrix 600 of the pixel units 300 can be produced using the mesh pattern (d) of the diffraction optical element (DOE) 1800 to simplify the production process and increase the production rate. For example, the first subpixels 410 to the fourth subpixels 440 may be produced by the matrix dot pattern (a) or the quadrilateral pattern (e) of the diffraction optical element (DOE) 1800, but not limited there to. This can also simplify the production process and increase the production rate.

As described above, with respect to the laser colored product and the laser coloring method thereof of the invention, a laser coloring process can be directly performed on a metal surface to form a metal color pattern layer with high resolution. Each of the pixel units of the metal color pattern layer has a pixel width or a pixel length between 1 μm to 500 μm so that the goal of producing high resolution color patterns can be achieved. Subpixels are produced in each of the pixel units for color mixing in order to increase the number of colors of the pixel units. By directly converting the metal layer into a metal color pattern layer, the laser coloring process of the invention decreases thermal effect and does not require the use of dyeing pigments. The laser coloring process of the invention is relatively clean and safe. It does not cause environmental pollution nor occupational injury for practitioners, so as to decrease environmental pollution and meet the requirement of modern environmental protection. In addition, the laser coloring process can achieve efficient heat dissipation and decrease heat accumulation in local areas of the metal surface of the processing workpiece, so that the imperfection of color cast or uneven color in local areas may be reduced.

The invention has been described by the above related embodiments. However, the above embodiments are only example for implementing the invention. It is noted that the disclosed embodiments do not limit the scope of the invention. On the contrary, modifications and equivalent arrangements included within the spirit and scope of the claims are included in the scope of the invention.

What is claimed is:

1. A laser coloring method, comprising:
providing a processing workpiece, wherein the processing workpiece includes a processing part, the processing part includes a pattern region, the processing part within the pattern region includes an inner portion and an outer layer, and the outer layer includes a metal material; and
irradiating, by performing a laser coloring system, the outer layer of the pattern region in stages to convert the outer layer of the pattern into a metal color pattern layer, the metal color pattern layer includes the metal material or a metal compound included with the metal material, the metal color pattern layer includes a plurality of pixel units arranged in arrays, wherein each of the pixel units includes a pixel color, and each of the pixel units has a pixel width or a pixel length between 1 μm to 500 μm.

2. The laser coloring method according to claim 1, wherein the processing part includes a metal plate.

3. The laser coloring method according to claim 1, further comprising: loading a first set of laser irradiating program or parameter to let the metal color pattern layer form a metal nanostructure that reflects ambient light to produce plasmon color before irradiating the outer layer of the pattern region in stages by performing a laser coloring system.

4. The laser coloring method according to claim 1, wherein before irradiating the outer layer of the pattern region in stages performing the laser coloring system, the laser coloring method further comprising:
forming a laser-induced periodical microstructure on the metal color pattern layer and reflect ambient light to produce plasmon color, by loading a second laser irradiating program or parameter.

5. The laser coloring method according to claim 1, wherein irradiating the outer layer of the pattern region in stages before performing the laser coloring system, the laser coloring method further comprising:
forming a metal compound film on the metal color pattern layer and reflect ambient light to produce film interference color, by loading a third laser irradiating program or parameter.

6. The laser coloring method according to claim 5, wherein the metal alloy film has a thickness between 1 nm to 1000 nm.

7. The laser coloring method according to claim 5, wherein irradiating the outer layer of the pattern region by performing the laser coloring system under the ambient atmosphere, oxygen atmosphere or nitrogen atmosphere, and converting the metal material into the metal alloy, the metal alloy includes metal oxynitride, metal oxide or metal nitride.

8. The laser coloring method according to claim 1, wherein each of the pixel units includes at least two subpixels, the laser coloring system is performed to irradiate a surface of each of the subpixels of the pixel units, the surface of each of the subpixels is converted into the metal color pattern layer, and the metal color pattern layer of each of the subpixels includes a subpixel color.

9. The laser coloring method according to claim 1, wherein each of the pixel units includes at least three subpixels, the laser coloring system is performed to irradiate a surface of each of the subpixels of the pixel units, the surface of each of the subpixels is converted into the metal color pattern layer, and the metal color pattern layer of each of the subpixels includes a subpixel color.

10. A laser colored product, comprising:
a processing part comprising an inner portion and a pattern portion; and
a metal color pattern layer, disposed on the inner portion of the pattern portion, the metal color pattern layer includes a metal material or a metal compound included with the metal material, the metal color pattern layer includes a plurality of pixel units arranged in arrays, wherein each of the pixel units includes a pixel color, each of the pixel units has a pixel width or a pixel length between 1 μm to 500 μm.

11. The laser colored product according to claim 10, wherein the processing part includes a metal plate.

12. The laser colored product according to claim 13, wherein a thickness of the metal color pattern layer ranges between 1 μm to 1000 μm.

13. The laser colored product according to claim 10, wherein the metal color pattern layer includes a metal nanostructure reflecting ambient light to produce plasmon color.

14. The laser colored product according to claim 10, wherein the metal color pattern layer includes a laser-induced periodical microstructure reflecting ambient light to produce plasmon color.

15. The laser colored product according to claim 10, wherein the metal color pattern layer includes a metal compound film reflecting ambient light to produce film interference color.

16. The laser colored product according to claim 10, wherein the metal compound of the metal material includes metal oxynitride, metal oxide or metal nitride.

17. The laser colored product according to claim 10, wherein a thickness of the metal compound ranges between 1 nm and 1000 nm.

18. The laser colored product according to claim 10, wherein the processing part further includes a nonpattern region relative to the pattern region, and the nonpattern region of the processing part further includes an outer layer.

19. The laser colored product according to claim 10, wherein each of the pixel units includes at least two subpixels, and each of the subpixels includes a subpixel color.

20. A laser coloring system, comprising:
a laser source irradiating a laser beam;
a scanning system receiving the laser beam and irradiating the laser beam to an outer layer of a processing workpiece within a pattern region, irradiating the outer layer of the pattern region in stages to convert the outer layer into a metal color pattern layer, the metal color pattern layer includes a metal material or a metal compound included with the metal material, the metal color pattern layer includes a plurality of pixel units arranged in arrays, wherein each of the pixel units includes a pixel color, each of the pixel units has a pixel width or a pixel length between 1 μm to 500 μm; and
a control system electrically connecting to the laser source and the scanning system to control the laser source and the scanning system.

21. The laser coloring system according to claim 20, further comprising a shutter disposed between the laser source and the scanning system, wherein the shutter receives the laser beam and controls time for passing through the shutter of the laser beam.

22. The laser coloring system according to claim 21, further comprising a visible light decaying element disposed between the shutter and the scanning system, the visible light decaying element receives the laser beam and modifies power of the laser beam.

23. The laser coloring system according to claim 21, further comprising a laser beam expander disposed between the shutter and the scanning system, the beam expander receives the laser beam and modifies a diameter of a laser speckle of the laser beam.

24. The laser coloring system according to claim 21, further comprising a diffraction optical element disposed between the shutter and the scanning system, the diffraction optical element receives the laser beam and modifies a pattern of a laser speckle of the laser beam.

25. The laser coloring system according to claim 20, wherein the scanning system comprises a first laser scanning mirror, a second laser scanning mirror and a F-theta lens, the first laser scanning mirror and the second laser scanning mirror control irradiating position of the laser beam on the outer surface, and the F-theta lens focuses the laser beam on the outer layer of the processing workpiece.

26. The laser coloring system according to claim 20, further comprising a multi-axis processing platform, and the processing workpiece is disposed on the multi-axis processing platform.

27. The laser coloring system according to claim 20, further comprising a heat dissipating platform and a thermo-electric cooling chip, the processing workpiece is disposed on the heat dissipating platform, and the thermo-electric cooling chip is attached under the heat dissipating platform.

28. The laser coloring system according to claim 20, further comprising a heat dissipating platform and a heat dissipating fin, the processing workpiece is disposed on the heat dissipating platform, and the heat dissipating fin is attached under the heat dissipating platform.

29. The laser coloring system according to claim 20, further comprising a processing groove and a solution, the processing workpiece is disposed in the processing groove, and the solution surrounds or covers the processing workpiece.
